(19) United States
(12) Patent Application Publication
(10) Pub. No.: US 2017/0353033 A1
(43) Pub. Date: Dec. 7, 2017

(54) POWER SYSTEM STABILIZATION DEVICE AND METHOD

(71) Applicants: HITACHI, LTD., Tokyo (JP); CHUBU ELECTRIC POWER CO., INC., Nagoya-shi, Aichi (JP)

(72) Inventors: Eisuke KURODA, Tokyo (JP); Yasuo SATO, Tokyo (JP); Taichirou KAWAHARA, Tokyo (JP); Kouichi HARA, Tokyo (JP); Kouichi YOKOI, Aichi (JP); Keisuke KATSURAGI, Aichi (JP); Toshihito ZASHIBO, Aichi (JP); Takumi MATSUBARA, Aichi (JP); Makoto KUWABARA, Aichi (JP)

(73) Assignees: HITACHI, LTD., Tokyo (JP); CHUBU ELECTRIC POWER CO., INC., Nagoya-shi, Aichi (JP)

(21) Appl. No.: 15/537,986

(22) PCT Filed: Nov. 25, 2015
(86) PCT No.: PCT/JP2015/083002

§ 371 Date: Jun. 20, 2017

(30) Foreign Application Priority Data
Dec. 26, 2014 (JP) 2014-265372

(51) Int. Cl. H02J 3/24; G05B 19/042; H02J 3/00

(52) U.S. Cl. CPC H02J 3/24; G05B 19/042; H02J 2003/001; G05B 2219/2639

(57) ABSTRACT

A power system stabilization device for the stabilization control of a power system, includes an indicator calculation unit for calculating an acceleration index, which is an index representing the acceleration of a generator for supplying electric power to the power system, by using the generator output, which is the output of the generator, and the generator phase difference that indicates the temporal change of the phase angle of the generator output; a threshold value determining unit for determining whether or not the acceleration index exceeds a preset threshold value; and a control command unit for generating a control command for control details that constitute a correction to the stabilization control, set in advance for the threshold value, when the acceleration index exceeds the threshold value.

### TECHNICAL FIELD

This invention relates to a power system stabilization device configured to control a generator in order to prevent, when a failure has occurred in a power system due to lightning or other reasons, the failure from influencing the power system.

### BACKGROUND ART

When a failure has occurred due to lightning or other reasons in a bus or a transmission line, which is a component in a power system, a voltage of the power system is decreased and an electric output transmitted from a generator falls below input energy to the generator, so that the generator is accelerated. A plurality of generators coupled to the power system operate in synchronization with one another. Once the acceleration is generated in a part of the generators, a synchronization deviation occurs among the generators. When the synchronization deviation increases, the number of disturbed generators increases, and the synchronization among the generators cannot be maintained, resulting in loss of synchronization. The occurrence of the loss of synchronization may lead to a massive blackout in the worst case.

For measures against such a phenomenon, development has been made on various kinds of power system stabilization devices configured to specify a generator having a large acceleration and disconnect the generator from a power system (herein after referred to as “generator shedding”), thereby suppressing the synchronization deviation to stabilize the system. A calculation method in the power system stabilization device is roughly classified into “pre-calculation” and “post-calculation”.

The pre-calculation power system stabilization device is configured such that, before the occurrence of a failure, periodically measured data in a power system before the occurrence of the failure is used to periodically determine stabilization measures (such as generator shedding) by stability calculation for a failure that is assumed to occur in the power system set in advance (hereinafter referred to as “assumed failure”) (hereinafter referred to as “pre-calculation”), and the stabilization measures determined in advance are taken when a failure occurs, thereby maintaining the stability of the system. Control effects become higher as the stabilization measures are taken much earlier after the occurrence of a failure. Thus, the pre-calculation capable of determining stabilization measures in advance and immediately executing control when a failure occurs is advantageous in that the control effects are high.

The post-calculation power system stabilization device is configured such that, after the occurrence of a failure, stabilization measures are determined by stability calculation using one or both of data in a power system constantly measured before the occurrence of a failure and data in the power system constantly measured after the occurrence of the failure (hereinafter referred to as “post-calculation”, and the stabilization measures are immediately executed, thereby maintaining the stability of the system. The pre-calculation involves stability calculation using measured data in the power system before the occurrence of a failure, but the post-calculation involves stability calculation using one or both of data in the power system constantly measured before the occurrence of a failure and data in the power system constantly measured after the occurrence of the failure. Thus, the post-calculation is advantageous in that control that is more adapted to an actual system state than that by the pre-calculation can be executed.

One background art in this technical field is PTL 1. PTL 1 describes “a system stabilization control system configured to be applied to a power system including a plurality of electric power plants formed from a plurality of generators and configured to stabilize the power system by executing generator control suited for an accident condition, the system stabilization control system being configured to: execute main control by a pre-calculation method in which stability determination based on the equal-area method is executed for each accident case assumed in advance to calculate the amount of control; and subsequently execute, when the amount of control by the main control is insufficient, correction control by a post-calculation method in which stability determination based on the equal-area method is executed on the basis of measurement information after the occurrence of an accident to calculate the amount of control” (see abstract).

Another background art in this technical field is PTL 2. PTL 2 indicates that “an unbalance amount (DP value) among generators for deceleration force, which indicates a difference in stability in a system configuration after failure clearance, is used as a stability index, the value of the stability index is compared with a threshold set in advance, and when the DP value is larger than the threshold, it is provisionally determined that the power system is unstable against an assumed disturbance (screening), and detailed stability calculation is executed to determine the stability of the power system in detail” (see abstract).

Another background art in this technical field is PTL 3. PTL 3 describes “a power system prevention and control apparatus including: system information collection means for collecting power system connection states and power supply and demand states as system information; power flow state calculation means for calculating a system power flow state on the basis of the system information collected by the system information collection means and system facility data; determination means for determining whether the power system is stable for each assumed disturbance on the basis of a relation between a value of unbalance of acceleration energy among generators and a reference value set in advance, which is determined on the basis of the output of each generator at a plurality of assumed disturbance occurrence time points in the current power flow state determined by the power flow state calculation means; output adjustment amount calculation means for determining, for an assumed disturbance with which the power system is determined to be unstable by the determination means, a generator output at the corresponding assumed disturbance occurrent time point and calculating an output adjustment amount of the generator necessary for maintaining transient stability by nonlinear programming; and control means for adjusting the generator output on the basis of the output adjustment amount of the generator determined by the output adjustment calculation means, thereby improving the transient stability of the system” (see abstract).

### CITATION LIST

### Patent Literature

[PTL 1]
Japanese Patent Application Publication No. 2013-66262
[PTL 2]
Japanese Patent Application Publication No. H7-135738
[PTL 3]
Japanese Patent No. 2603929

### SUMMARY OF INVENTION

### Technical Problem

In the future, a power supply (output fluctuating power supply) whose output fluctuates depending on weather conditions, such as renewable energy (solar power generation, wind-power generation, and the like), is planned to be widely introduced in a power system. As a result of the recent advancement of deregulation of electric utilities around the world, facility investment for power systems is suppressed, and the volume of power flow flowing through existing transmission lines is increasing (heavy power flow). If the power flow greatly fluctuates in the heavy power flow state, the stability of the power system (system stability) may deteriorate, which makes it difficult to supply electric power stably when a failure occurs in the power system. In the worst case, the failure may be cascaded to cause a massive blackout. Power system stabilization device that can support such an unstable phenomenon are sought after.

The conventional pre-calculation power system stabilization device does not assume an output fluctuation of the output fluctuating power supply, and hence an error may occur in periodically measured data in a power system before the occurrence of a failure, and an error may occur in the amount of control for pre-calculation stabilization measures. When the output fluctuates in the direction in which the system stability deteriorates, there is a problem in that the amount of control is insufficient, and a massive blackout occurs in the worst case.

As described in PTL 1, the post-calculation power system stabilization device is configured to accumulate data on generator output or transmission line active power before and after the occurrence of a failure, create a P-δ curve during an accident and after the clearance of the accident by using a generator phase angle calculated from the data and information on the accumulated generator output, calculate the value of acceleration energy VA and the value of deceleration energy VD, and compare the magnitudes of both the energies, thereby determining the stability and executing the control. Thus, the stability of a system can be maintained even when an output fluctuation of the output fluctuating power supply is not assumed.

However, the stability is determined on the basis of the equal-area method, and the control is executed, and hence an infinite bus needs to be prepared for a power system to which a generator or an electric power plant to be subjected to stabilization control (stabilization subject) is coupled via a transmission line. It is therefore difficult to take into consideration the influence of other generators in the power system on the generator or the electric power plant serving as the stabilization subject. For the application as a power system stabilization device for a power system in practice, there is a problem in that labor is required for much parameter tuning (parameter settling).

It is an object of this invention to provide a technology capable of maintaining stability of a power system by stabilization control even when a power flow of the power system has increased to the degree that is not assumed by pre-calculation.

### Solution to Problem

A power system stabilization device according to one aspect of this invention performs stabilization control of a power system, and includes: an indicator calculation unit configured to calculate, by using a generator output that is an output of a generator configured to supply electric power to the power system and a generator phase difference that indicates a change of a phase angle of the generator output with respect to time, an acceleration index that is an index representing an acceleration of the generator; a threshold value determining unit configured to determine whether the acceleration index exceeds a threshold set in advance; and a control command unit configured to issue, when the acceleration index exceeds the threshold, a control command for control details for correcting the stabilization control, which are set for the threshold in advance.

### Advantageous Effects of Invention

This invention can execute stabilization control capable of maintaining stability of power system against a power flow fluctuation that is not assumed by pre-calculation.

### BRIEF DESCRIPTION OF DRAWINGS

FIG. 1 is a diagram illustrating an example of an overall configuration of a power system stabilization device.

FIG. 2 is a diagram illustrating an example of a hardware configuration of the power system stabilization device and an overall configuration of a power system.

FIG. 3 is a diagram illustrating the outline of information to be transmitted and received between the power system stabilization device and a central stabilizer, a failure detection apparatus, a measurement apparatus, and a generator control apparatus.

FIG. 4 is a diagram illustrating contents of program data in the power system stabilization device.

FIG. 5 is a diagram illustrating system data about generator phase difference data.

FIG. 6 is a diagram illustrating system data about threshold and control data.

FIG. 7 is a diagram illustrating system data about determination control result data.

FIG. 8 is a flowchart illustrating the whole processing in the power system stabilization device.

FIG. 9 is a flowchart illustrating processing in a generator phase difference calculation unit.

FIG. 10 is a diagram for describing the calculation of a generator phase difference immediately after a failure.

FIG. 11 is a diagram for describing the calculation of the generator phase difference.

FIG. 12 is a flowchart illustrating processing in a generator energy calculation unit.

FIG. 13 is a diagram for describing the calculation of generator energy.

FIG. 14 is a diagram for describing processing in a threshold value determining unit.

FIG. 15 is a diagram for describing processing in a threshold value determining unit.

FIG. 16 is a diagram illustrating an overall configuration of the central stabilizer.

FIG. 17 is a diagram illustrating a hardware configuration of the central stabilizer and an overall configuration of the power system.

FIG. 18 is a diagram illustrating contents of program data in the central stabilizer.

FIG. 19 is a flowchart illustrating the whole processing in the central stabilizer.

FIG. 20 is a flowchart illustrating processing in a stability limit search unit.

FIG. 21 is a flowchart illustrating processing in a transient stability direction search flow.

FIG. 22 is a configuration diagram of the power system for describing the processing in the transient stability direction search flow.

FIG. 23 is a diagram illustrating a power flow fluctuation in each area for describing the processing in the transient stability direction search flow.

FIG. 24 is a flowchart illustrating processing in a threshold and correction control detail calculation unit.

FIG. 25 is a diagram illustrating how a stability limit search unit searches for a stability limit.

FIG. 26 is a diagram for describing processing in a generator energy calculation unit.

FIG. 27 is a diagram for describing processing in a threshold and correction control detail calculation unit.

FIG. 28 is a time chart illustrating timings from the occurrence of a failure to each control in the power system stabilization device.

FIG. 29 is a diagram illustrating an example of search range data.

FIG. 30 is a diagram illustrating an example of assumed failure data.

FIG. 31 is a diagram illustrating how the stability is improved by threshold determination and generator control.

### DESCRIPTION OF EMBODIMENTS

Embodiments of this invention are described with reference to the accompanying drawings.

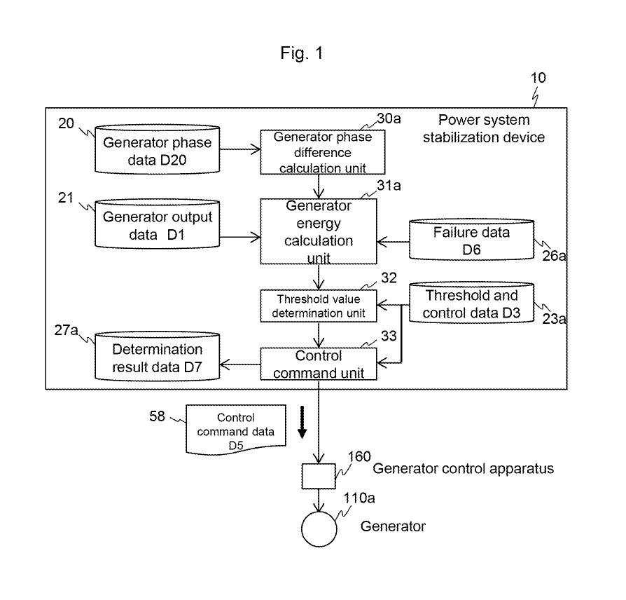

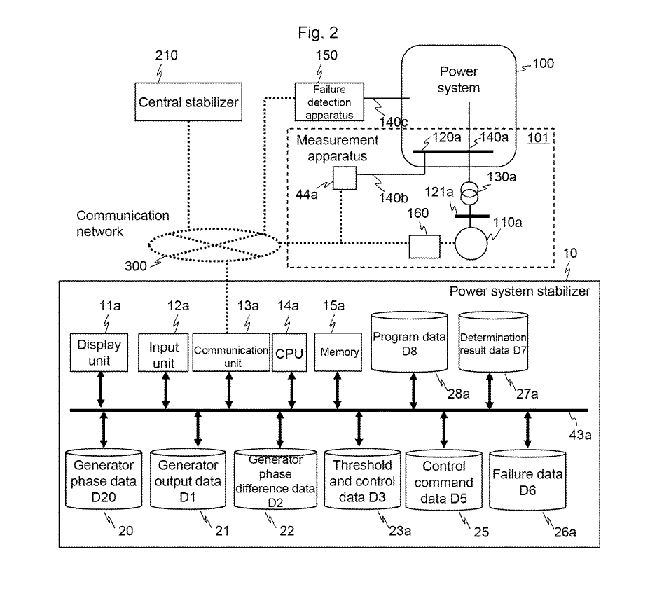

First, in regard to an example of a power system stabilization device according to this embodiment, an example of an overall configuration of input, output, and processing is described with reference to FIG. 1. Next, hardware configurations of a power system 100, a partial power system 101, a central stabilizer 210, the power system stabilization device 10, a failure detection apparatus 150, a measurement apparatus 44a, and a generator control apparatus 160 are described with reference to FIG. 2.

FIG. 1 is a block diagram illustrating an example of the overall configuration of the power system stabilization device 10 according to this embodiment. Referring to FIG. 1, the power system stabilization device 10 includes a generator phase difference calculation unit 30a, a generator energy calculation unit 31a, a threshold value determining unit 32, and a control command unit 33.

The power system stabilization device 10 holds generator phase data D20, generator phase difference data D2 (not shown), generator output data D1, failure data D6, threshold and control data D3, and determination result data D7, and transmits control command data D5 to the generator control apparatus 160 configured to control a generator 110a.

Input data to the power system stabilization device 10 are the generator phase data D20, the generator phase difference data D2, the generator output data D1, the failure data D6, and the threshold and control data D3.

The power system stabilization device 10 calculates the generator phase difference data D2 from the generator phase data D20 before and after the occurrence of a failure, and calculates generator energy by using the generator output data D1 and the calculated generator phase difference data D2. The threshold and control data D3 is data calculated by the central stabilizer 210 and notified to the power system stabilization device 10, and includes a threshold used for failure threshold determination and information on what control is to be executed for a failure at each location. How to determine the threshold is described later in the description of the central stabilizer 210. The power system stabilization device 10 executes threshold determination with use of the threshold and control data D3 and the calculated generator energy, and calculates and transmits the control command data D5 to the generator control apparatus 160 coupled to the generator 110a and an electric power plant including the generator 110a on the basis of the result of the determination.

The generator phase difference calculation unit 30a in the power system stabilization device 10 calculates the generator phase difference D2 by using the generator phase data D20 before and after the occurrence of a failure. The generator energy calculation unit 31a in the power system stabilization device 10 calculates generator energy by using the failure data D6, the generator phase difference D2, and the generator output data D1. The threshold value determining unit 32 in the power system stabilization device 10 determines whether the generator energy exceeds a threshold by using the threshold and control data D3 and the generator energy. The generator energy is energy for accelerating or decelerating a generator, and can be regarded as an index representing acceleration (acceleration index). The control command unit 33 in the power system stabilization device 10 selects an appropriate control detail on the basis of the result of the threshold determination and the threshold and control data D3, transmits the control command data D5 having the selected control detail to the generator control apparatus 160, and generates the determination result data D7. For example, when the control detail is generator tripping control (generator shedding), the generator control apparatus 160 that has received the control command is shut down from the power system 100 in accordance with the control command.

The above-mentioned generator phase difference may be calculated by an external apparatus instead of the power system stabilization device 10.

Each of the generator phase data D20, the generator output data D1, the failure data D6, and the threshold and control data D3 may be acquired as necessary or may be stored in a predetermined database in advance.

The generator tripping control (generator shedding) has been exemplified as a control command. Other examples of the control command include load shutdown control (load control) and phase modifying equipment control.

FIG. 2 is a diagram illustrating an example of a hardware configuration of the power system stabilization device 10 and an overall configuration of the power system. FIG. 2 illustrates the power system 100, its partial power system 101, the central stabilizer 210, the power system stabilization device 10, and the failure detection apparatus 150. The measurement apparatus 44a and the generator control apparatus 160 are illustrated inside the partial power system 101.

The power system 100 includes any one or more of the generator 110a, a transformer 130a, the measurement apparatus 44a, the failure detection apparatus 150, a load (not shown), and other measurement apparatus and control apparatus, which are each coupled to the power system 100 via a branch (line) 140a and a node (bus) 120a.

The power system 100 includes one or more partial power systems 101. The partial power system 101 includes anyone or more of the generator 110a, the branch 140a, the transformer 130a, a node 121a, the measurement apparatus 44a, and the generator control apparatus 160, which are each coupled to the partial power system 101 via the node 120a.

Examples of the generator 110a include a generator that can be shut down from the power system 100 in case of emergency, such as a thermal power generator. The generator control apparatus 160 controlled by the power system stabilization device 10 is assumed to control the generator 110a as a control subject. However, when the power system stabilization device 10 executes control for maintaining transient stability as well as other voltage stability and frequency stability, the power system stabilization device 10 may directly or indirectly control a power supply, a load, a battery, and other control devices as control subjects.

The load includes a home electric appliance in a consumer which is not assumed to be controlled but only consumes electric power, such as an air conditioner, a refrigerator, and a washing machine, and a controllable load which is assumed to be controlled, such as a heat pump. Even an apparatus which is not assumed to be controlled may be controlled via a home server configured to communicate with devices using electric power, such as a Home Energy Management System (HEMS). When the power system stabilization device 10 controls loads, the power system stabilization device 10 may perform control for each device serving as individual loads, may control the load for each individual consumer, or may perform control on a set of a plurality of loads. The power system stabilization device 10 may control a load via an aggregator who implements energy management for cluster housing or buildings on consignment.

Examples of the battery include a rechargeable secondary battery, an EV storage battery, and a flywheel.

Examples of the measurement apparatus 44a include an apparatus (such as a VT (Voltage Transformer), a PT (Potential Transformer), and a CT (Current Transformer)) configured to measure any one or more of a node voltage V, a branch current I, a power factor Φ, active power P, and reactive power Q. The measurement apparatus 44a is a telemeter (TM) having a function of transmitting data including data measurement location identification ID and built-in timestamps of the measurement apparatus.

The measurement apparatus 44a may include an apparatus configured to measure absolute time-added power information (voltage phasor information) using GPS, a Phasor Measurement Units (PMU), and other measurement apparatuses.

In FIG. 2, the measurement apparatus 44a is illustrated as being located outside the power system stabilization device 10. However, the measurement apparatus 44a may be included inside the generator control apparatus 160 or the power system stabilization device 10.

Examples of the failure detection apparatus 150 include a failure detection relay, such as an undervoltage relay. Examples of the generator control apparatus 160 include a control board installed in an electric power plant capable of controlling one (uniaxial) or more (polyaxial) generators. The control board is a terminal apparatus configured to receive control commands from, for instance, the power system stabilization device 10, and is also called “terminal equipment”.

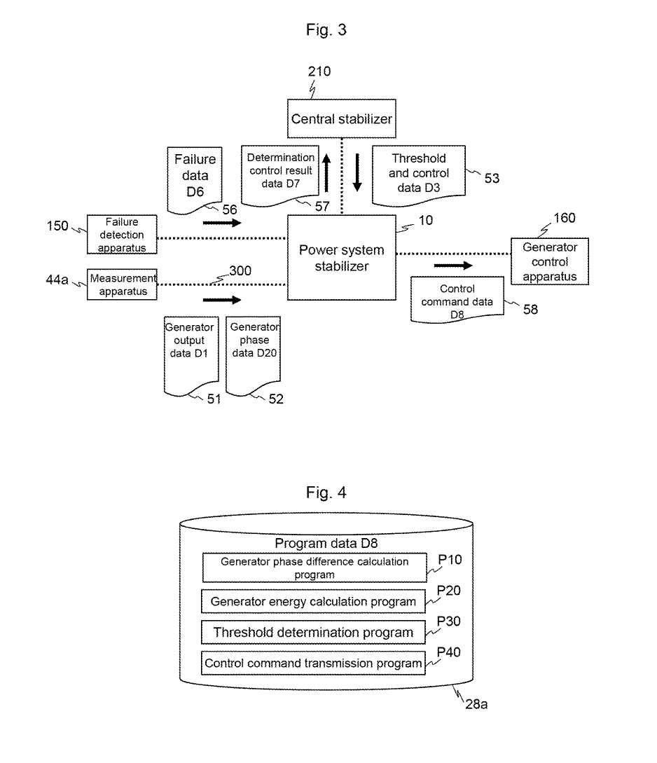

Referring to FIG. 3, various kinds of data to be transmitted and received among the central stabilizer 210, the power system stabilization device 10, the failure detection apparatus 150, the measurement apparatus 44a, and the generator control apparatus 160 via a communication network 300 are described. FIG. 3 is a diagram showing an example of a schematic flow of information to be transmitted and received among the power system stabilization device 10, the central stabilizer 210, the failure detection apparatus 150, the measurement apparatus 44a, and the generator control apparatus 160. The central stabilizer 210 is coupled to a communication unit 13a in the power system stabilization device 10 via the communication network 300. The central stabilizer 210 transmits information 53 (threshold and control data D3) to the power system stabilization device 10, and receives information 57 (determination control result data D7) from the power system stabilization device 10.

The failure detection apparatus 150 coupled to the power system 100 is similarly coupled to the power system stabilization device 10 via the communication network 300, and transmits information 56 (failure data D6) to the power system stabilization device 10. The failure data D6 to be transmitted by the failure detection apparatus 150 includes the location and condition of a failure. The condition is information indicating the state of a failure, and includes a value that can be used for threshold determination. The power system stabilization device 10 collates the failure data D6 with the threshold and control data D3 to perform threshold determination, and executes control on the basis of the result of the determination.

The measurement apparatus 44a is similarly coupled via the communication network 300 to the power system stabilization device 10 that is coupled to the generator 110a, the bus 121a, the transformer 130a, and the bus 120a in the partial power system 101 via a branch 140b. The measurement apparatus 44a transmits information 51 (generator output data D1) and information 52 (generator phase data D20) to the power system stabilization device 10.

The generator control apparatus 160 configured to transmit a control command to the generator 110a in the partial power system 101 is similarly coupled to the power system stabilization device 10 via the communication network 300, and receives information 58 (control command data D8) from the power system stabilization device 10.

Various kinds of data illustrated in FIG. 3 may be communicated in the form including a specific number for identifying data and a timestamp in addition of the original data.

Returning to FIG. 2, the configuration of the power system stabilization device 10 is described.

The power system stabilization device 10 includes a display unit 11a, an input unit 12a such as a keyboard and a mouse, the communication unit 13a, a computer or computer server (CPU: Central Processing Unit) 14a, a memory 15a, and various kinds of databases (generator phase database 20, generator phase difference database 22, generator output database 21, failure database 26a, threshold and control database 23a, determination result database 27a, control command database 25, and program database 28a). These components are coupled to a bus line 43a.

The display unit 11a is configured as, for example, a display apparatus. Alternatively, for example, the display unit 11a may use a printer apparatus or a voice output apparatus in place of, or together with, the display apparatus.

The input unit 12a includes at least one of a pointing apparatus such as a keyboard switch and a mouse, a touch panel, and a voice instruction apparatus.

The display unit 11a and/or the input unit 12a is not necessarily required.

The communication unit 13a includes a circuit and a communication protocol used for connection to the communication network 300.

The CPU 14a reads a predetermined computer program from a program database 24a and executes the read computer program. The CPU 14a may be configured as one or more semiconductor chips, or may be configured as a computer apparatus such as a calculation server.

The memory 15a is configured as, for example, a RAM (Random Access Memory). The memory 15a stores therein a computer program read from the program database 28a, and stores therein calculation result data and image data necessary for each processing. Screen data stored in the memory 15a is transmitted to the display unit 11a and displayed. An example of the screen displayed on the display unit 11a is described later.

Referring to FIG. 4, stored contents in the program database 28a are described. FIG. 4 is a diagram illustrating an example of program data in the power system stabilization device 10. In this example, a generator phase difference calculation program P10, a generator energy calculation program P20, a threshold determination program P30, and a control command transmission program P40 are stored in the program database 28a.

Returning to FIG. 2, the CPU 14a executes calculation programs (generator phase difference calculation program P10, generator energy calculation program P20, threshold determination program P30, and control command transmission program P40) read from the program database 28a into the memory 15a, thereby calculating a generator voltage phase difference, calculating generator energy, calculating threshold determination, calculating a control command value, instructing image data to be displayed, and searching for data in various kinds of databases.

The memory 15a is a memory configured to temporarily store calculation temporary data and calculation result data, such as display image data, control data, and control result data. The CPU 14a generates and displays necessary image data on the display unit 11a (for example, display screen). The display unit 11a in the power system stabilization device 10 may be only a simple screen used to rewrite each control program and database.

As understood from FIG. 2, roughly divided eight databases are stored in the power system stabilization device 10. The generator phase database 20, the generator output database 21, the generator phase difference database 22, the threshold and control database 23a, the control command database 25, the failure database 26a, and the determination result database 27a other than the program database 28a are described below.

In the generator phase database 20, a voltage phase angle at the node 120a that couples the power system 100 and the partial power system 101 to each other is stored as the generator phase data D20. The voltage phase angle may be measured with a measurement apparatus using PMU or GPS.

In the generator output database 21, the output of a generator or an electric power plant, which is a line power flow at the branch 140a coupled to the node 120a that couples the power system 100 and the partial power system 101 to each other is stored as the generator output data D1. A line power flow P is calculated from a current I and a voltage V measured by VT or PT, thereby measuring the output of the generator or the electric power plant. The output of the generator or the electric power plant may be the output of a generator for each axis or may be the total output of an electric power plant.

In the generator phase difference database 22, the generator phase difference data D2 at the node 120a, which is calculated by the generator phase difference calculation unit 30a by using the voltage phase angle at the node 120a that couples the power system 100 and the partial power system 101 to each other, the voltage phase angle being stored in the generator phase database 20.

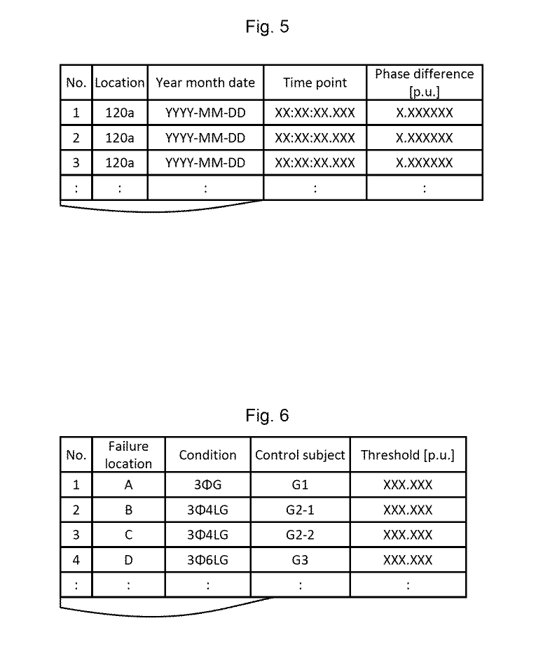

Reference is now made to data in FIG. 5. FIG. 5 is an example of the generator phase difference D2 at the node 120a. In this example, the generator phase difference data D2 is stored for each location and time section. A method of calculating the generator phase difference data D2 is described later.

In the threshold and control database 23a, the threshold and control data D3 is stored. Reference is now made to data in FIG. 6. In the data in FIG. 6, a failure condition, a control subject, and a threshold corresponding to each failure location are stored. Although not illustrated in FIG. 6, one or more thresholds may be present for one failure while divided on a time axis. The period of control is set in advance, and hence although not illustrated in FIG. 6, control is executed in a period determined in advance.

The control subject is basically one (uniaxial) generator, but may be a plurality of generators.

Although not illustrated in FIG. 6, first-stage control data D11 described later is also stored in the control data.

In the control command database 25, for example, a CB (Circuit Breaker) release signal to be transmitted from the power system stabilization device 10 to the generator control apparatus 160 is stored as the control command data D5 to be issued when a threshold is exceeded.

In the failure database 26a, the failure data D6 to be transmitted from the failure detection apparatus 150 to the power system stabilization device 10 is stored. The location and condition of a failure are stored in the failure data D6. The power system stabilization device 10 collates the failure data D6 with the threshold and control data D3 to perform threshold determination, thereby determining a control detail to be executed.

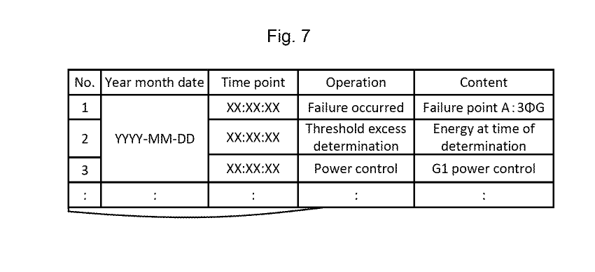

In the determination result database 27a, the determination result data D7 is stored. Reference is now made to data in FIG. 7. In the data in FIG. 7, what kind operation has occurred at each time and a specific content of the operation are stored. For example, what kind of failure has occurred at a time point, what kind of data causes the threshold excess in the operation of its threshold determination, and what kind of control has been executed at a time point. Although not illustrated in FIG. 7, the value of generator energy that has used for determination is also stored. When stability has not exceeded a threshold or when control has failed, this fact is recorded in the determination result data D7. The power system stabilization device 10 notifies the central stabilizer 210 of the determination result data D7.

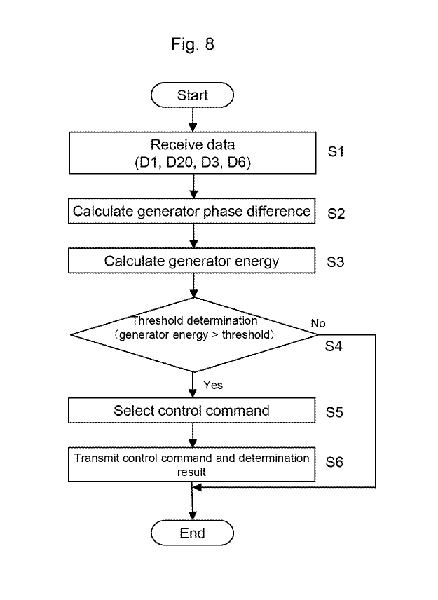

Next, calculation processing contents in the power system stabilization device 10 are described with reference to FIG. 8. FIG. 8 is a flowchart illustrating an example of the whole processing in the power system stabilization device 10.

First, the flow of the processing is briefly described.

The power system stabilization device 10 calculates a generator phase difference by using the generator output data D1 and the generator phase data D20 received from the measurement apparatus 44a, and stores the generator phase difference data D2 as the result of the calculation. The power system stabilization device 10 further calculates generator energy by using the generator output data D1 received from the measurement apparatus 44a and the calculated generator phase difference data D2, and accumulates the generator energy in the memory 15a. The power system stabilization device 10 further compares the calculated generator energy with a threshold in the threshold and control data D3 received from the central stabilizer 210, thereby determining whether the generator energy has exceeded the threshold.

When the generator energy has exceeded the threshold, the power system stabilization device 10 selects a control command by using the threshold and control data D3 and the failure data D6 received from the failure detection apparatus 150, and transmits the control command data D8 to the generator control apparatus 160. The power system stabilization device 10 then transmits the determination result data D7 to the central stabilizer 210, and finishes the calculation. In this case, various kinds of calculation results and the data accumulated in the memory in the course of calculation may be transmitted to the central stabilizer 210 and sequentially displayed on a screen of the central stabilizer 210. This configuration enables an operator to easily grasp operation states of the power system stabilization device 10. The control command data D8 is data on a control command such as a CB release signal, and is transmitted to the control board at the terminal equipment.

The power system stabilization device 10 may display, on the basis of the data described above, operating states on the screen, such as the states in which the power system is under monitoring, the threshold has been exceeded, and the control is being executed. This configuration enables an operator to easily grasp the operation states of the power system stabilization device 10. The power system stabilization device 10 may display the generator output, or may display generator energy and/or the threshold determination result.

Until the control is executed, screen display for the states from the reception of various kinds of data to the transmission of the control command and determination result is repeated.

Details of the above-mentioned processing are described with reference to FIG. 8.

Reference is made to FIG. 8. First, in Step S1, the power system stabilization device 10 receives data necessary for the calculation of a generator phase difference, the calculation of generator energy, the threshold determination, and the selection of a control command. In this case, the power system stabilization device 10 automatically receives the failure data D6 from the failure detection apparatus 150. The power system stabilization device 10 automatically receives the generator output data D1 and the generator phase data D20 from the measurement apparatus 44a at a constant cycle, and automatically stores the generator output data D1 and the generator phase data D20. The power system stabilization device 10 automatically receives the threshold and control data D3 from the central stabilizer 210 at a constant cycle, and automatically stores the threshold and control data D3.

Next, in Step S2, the power system stabilization device 10 calculates a generator phase difference by using the generator phase data D20 received in Step S1, and calculates and stores the generator phase difference data D2.

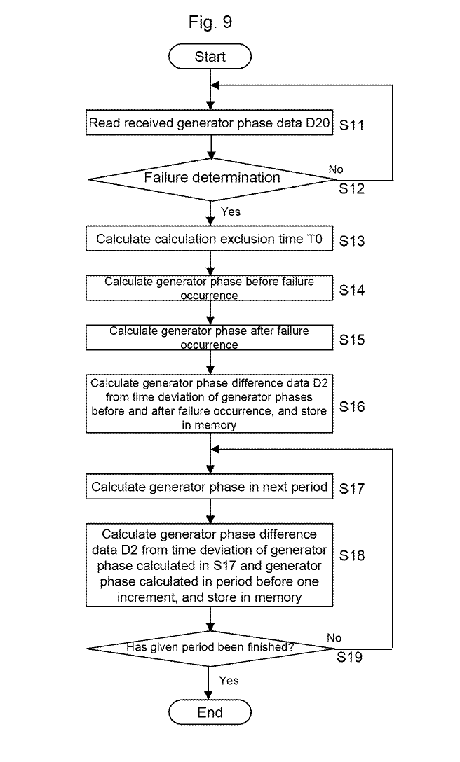

Referring to FIG. 9, the flow of calculating the generator phase difference is described. FIG. 9 is a flowchart for describing an example of processing in the generator phase difference calculation unit. FIG. 9 illustrates a method in which the generator phase data D20 is read and when a failure has occurred, the generator phase difference data D2 is calculated from the generator phase data D20 through Steps S11 to S19. The flow of the above-mentioned processing is described in detail below.

Reference is made to FIG. 9. First, in Step S11, the power system stabilization device 10 reads the generator phase data D20 received in Step S1 into the memory 15a. Next, in Step S12, the power system stabilization device 10 continuously calculates a phase average value in a predetermined period of time and examines a temporal change of the phase average value, thereby determining whether a failure has occurred on the basis of the result of the examination. In this example, the temporal change of the phase average value is the generator phase difference data D2.

The failure determination may be based on one or more of a temporal change of the generator phase data D20 and change amounts (voltage drops) and the like of other received data, such as the generator output data D1, the node voltage V, and the current I. For example, it may be determined that a failure has occurred when the amplitude of the voltage decreases and the phase of the voltage increases to be larger than a prescribed value.

When it is determined in the failure determination in Step S12 that no failure has occurred, the flow returns to Step S11.

When a failure has occurred, in Step S13, in order to exclude a region where the voltage has transiently decreased due to the failure and the phase is not accurately calculated from the calculation, the power system stabilization device 10 calculates a calculation exclusion time in the region on the basis of a time point at which the phase starts changing and a time point at which the change of the phase ends. For example, when there is a period during which a change rate of the phase with respect to time exceeds a certain threshold for a predetermined period of time, this period may be set as the period from the start of the phase change to the end of the phase change.

In Step S14, the power system stabilization device 10 calculates an average of generator phases from one increment of sampling before the calculation exclusion time calculated in Step S13 to a predetermined number of previous increments, thereby calculating a generator phase before the occurrence of the failure. Next, in Step S15, the power system stabilization device 10 calculates an average of generator phases from one increment after the calculation exclusion time calculated Step S13 to a predetermined number of subsequent increments, thereby calculating a generator phase after the occurrence of the failure.

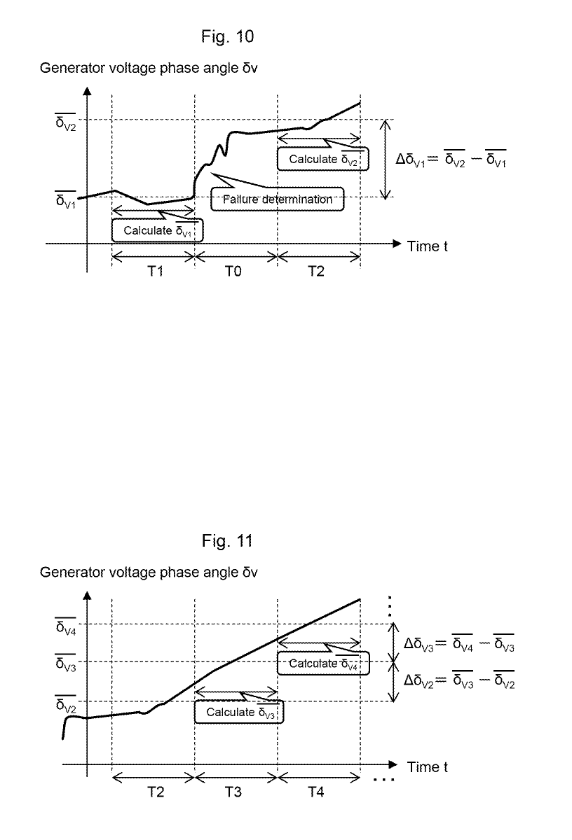

Now, an example of the calculation from Step S12 to Step S15 is illustrated in FIG. 10. FIG. 10 is a diagram illustrating an example of calculating a generator phase difference immediately after a failure.

In the failure determination in Step S12, the power system stabilization device 10 determines that a failure has occurred in a period during which a phase average value in a predetermined period of time T set in advance has abruptly changed as illustrated in FIG. 10. The calculation exclusion time in Step S13 is calculated by adding a margin set in advance to the period from the start of phase change to the end of phase change before and after the failure occurrent time. As illustrated in FIG. 10, T0 is a calculation exclusion time, which is a continuous time region where a change equal to or more than a certain threshold has not occurred. The calculation of the generator phase before the occurrence of the failure in Step S14 is executed in the manner that, as illustrated in FIG. 10, generator voltage phase angles δv in a predetermined period of time T1 are averaged to determine an average value δv1, and the obtained average value δv1 in the predetermined period of time T1 is set as the generator phase before the occurrence of the failure. The calculation of the generator phase after the occurrence of the failure in Step S15 is executed in the manner that, as illustrated in FIG. 10, generator voltage phase angles δv in a predetermined period of time T2 are averaged to determine an average value δv2, and the obtained average value δv2 in the predetermined period of time T2 is set as the generator phase after the occurrence of the failure.

Returning to FIG. 9, in Step S16, on the basis of the generator phase before the occurrence of the failure and the generator phase after the occurrence of the failure determined in Steps S14 and S15, the power system stabilization device 10 determines and stores an initial step amount Δδv1 of the generator phase difference data D2 by Expression (1).

[Math. 1]

Δδ_{V1}=δ̅_̅{̅V̅2̅}̅−δ̅_̅{̅V̅1̅}̅ (1)

Next, in Step S17, the power system stabilization device 10 calculates an average of a plurality of generator phases included in a cycle next to the cycle of the generator phase after the occurrence of the failure, that is, an average of generator phases from one increment after the generator phase used for the calculation in Step S14 to a predetermined number of subsequent increments, thereby calculating a generator phase in the next cycle.

In Step S18, the power system stabilization device 10 calculates the generator phase difference data D2 on the basis of a difference (time deviation) between the generator phase in the next cycle calculated in Step S17 and the generator phase after the occurrence of the failure calculated in Step S14, and stores the calculated generator phase difference data D2 in the memory.

Now, an example of the calculation from Step S17 to Step S18 is illustrated in FIG. 11. FIG. 11 is a diagram illustrating an example of calculating a generator phase difference.

The calculation of the generator phase in the next cycle in Step S17 is executed in the manner that, as illustrated in FIG. 11, generator voltage phase angles δv in a predetermined period of time T3 are averaged to determine an average value δv3, and the obtained average value δv3 in the predetermined period of time T3 is set as the generator phase in the next cycle. The calculation of a generator phase after the next cycle is similarly executed in the manner that generator voltage phase angles δv in a predetermined period of time T4 are averaged to determine an average value δv4, and the obtained average value δv4 in the predetermined period of time T4 is set as the generator phase after the next cycle.

In Step S18, on the basis of a pair of the generator phase after the occurrence of the failure and the generator phase in the next cycle and a pair of the generator phase in the next cycle and the generator phase after the next cycle, which are determined in Step S17, the power system stabilization device 10 determines the next step amount Δδv2 and the second next step amount Δδv3 of the generator phase difference data D2 by Expression (2) and Expression (3), respectively, and stores the determined step amounts in the memory.

[Math. 2]

Δδ_{V3}=δ̅_̅{̅V̅4̅}̅−δ̅_̅{̅V̅3̅}̅ (2)

[Math. 3]

Δδ_{V2}=δ̅_̅{̅V̅3̅}̅−δ̅_̅{̅V̅2̅}̅ (3)

The generator voltage phase angle δv in FIG. 10 and FIG. 11 is calculated in consideration of a time delay by filtering, because the generator voltage phase angle δv is subjected to filtering in order to exclude harmonics from a transient change of the generator voltage phase angle δv.

Returning to FIG. 9, in Step S19, when a predetermined period of time has not elapsed from the start of the calculation of the generator phase difference data D2, the power system stabilization device 10 returns to Step S17, and when a predetermined period of time has elapsed, the power system stabilization device 10 finishes the flow and returns to Step S11. Even when a failure is not determined to have occurred, the generator phase difference data D2 is calculated and held in the memory for a predetermined cycle, and updated. The calculation of the generator phase difference data D2 may be executed by the measurement apparatus 44a or may be executed by the power system stabilization device 10. While the failure determination is executed on the basis of the phase of the generator in this example, the failure determination may be executed on the basis of other indices such as the voltage and current of the generator and signals issued from the failure relay.

Returning to FIG. 8, in Step S3, the power system stabilization device 10 calculates generator energy by using the generator phase difference data D2 calculated in Step S2, the generator output data D1, and the threshold and control data D3, and stores the calculated generator energy in the memory.

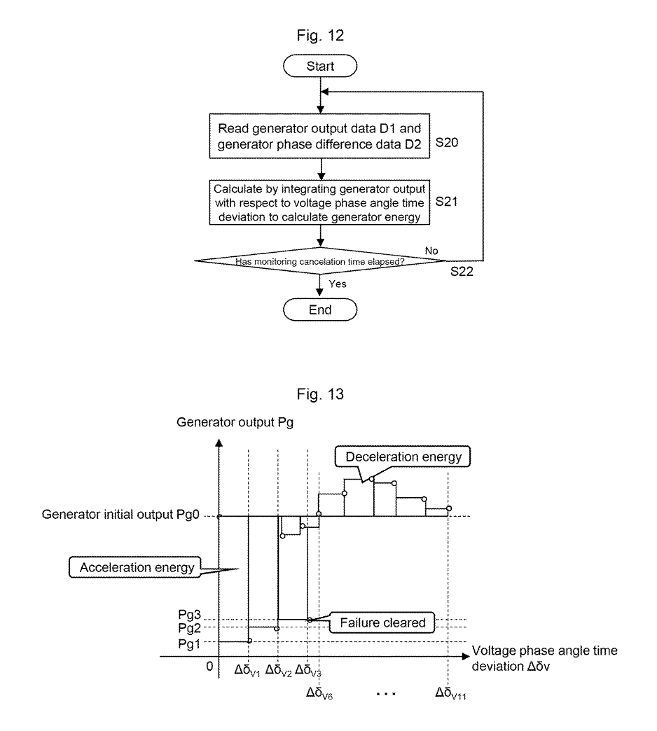

Referring to FIG. 12, the flow of the generator energy calculation is now described. FIG. 12 is a flowchart illustrating an example of processing in the generator energy calculation unit.

FIG. 12 illustrates a method in which the generator output data D1 and the generator phase difference data D2 are used integrate the generator output with respect to a time deviation of the generator voltage phase angle and calculate the generator energy through Steps S20 to S22. The flow of the above-mentioned processing is described in detail below. The generator phase difference data D2 is hereinafter referred to also as “voltage phase angle time deviation Δδv”.

First, in Step S20, the power system stabilization device 10 reads the generator output data D1 received in Step S1 and the generator phase difference data D2 calculated in Step S2 into the memory 15a. Next, in Step S21, the power system stabilization device 10 executes the integral calculation in the manner that rectangular areas formed by the generator voltage phase angle time deviation of the generator output for each predetermined time increment are integrated, thereby calculating the generator energy.

Referring to FIG. 13, an example of the calculation from Step S20 to Step S21 is now described. FIG. 13 is a diagram illustrating an example of the generator energy calculation.

As illustrated in FIG. 13, the reading of each data in Step S20 is started at a point at which a generator output Pg is a generator initial output Pg0 and the voltage phase angle time deviation Δδv is 0, and is continued until a predetermined monitoring cancellation time has elapsed. The monitoring cancellation time is set in advance.

In Step S21 in which the generator output is integrated with respect to the generator voltage phase angle time deviation to calculate generator energy, as illustrated in FIG. 13, the integral calculation is executed in the manner that, for each predetermined time increment, rectangular areas formed by the predetermined time and the generator voltage phase angle time deviation of the generator output are integrated. In a region where the generator output Pg is lower than the generator initial output Pg0, the area is calculated as acceleration energy. In a region where the generator output Pg is higher than the generator initial output Pg0, the area is calculated as deceleration energy. The generator energy may be calculated by integration of trapezoidal areas instead of integration of rectangular areas.

The acceleration energy and the deceleration energy based on the generator output Pg and the voltage phase angle time deviation Δδv as illustrated in FIG. 13 can be determined by Expression (4) and Expression (5). The generator output Pg may be an electric power plant output, which is the sum of outputs of a plurality of generators included in an electric power plant. In this example, a time deviation of the voltage phase angle at the bus of the generator is used as the voltage phase angle time deviation, but the voltage phase angle time deviation may be a time deviation of a voltage phase angle at an electric power plant bus. In consideration of the relation between the distance and transmission delay time, a difference between the voltage phase at the bus of the generator or the electric power plant and a voltage phase at a bus at a predetermined distance from the generator may be used as the voltage phase angle time deviation.

$$\begin{matrix}[ Math . 4 ] & \\ {E}_{A}^{′} = {\int }_{0}^{{Δδ}_{v 6}} ( {P}_{g 0} - {P}_{g} ) d Δδ & ( 4 ) \\ [ Math . 5 ] & \\ {E}_{D}^{′} = {\int }_{{Δδ}_{6}}^{{Δδ}_{11}} ( {P}_{g 0} - {P}_{g} ) d Δδ & ( 5 )\end{matrix}$$

where EA′ represents the acceleration energy and ED′ represents the deceleration energy.

Returning to FIG. 12, in Step S22, when a predetermined period of time has not elapsed from the start of the processing of the generator energy calculation, the power system stabilization device 10 returns to Step S20, and when a predetermined period of time has elapsed, the power system stabilization device 10 finishes the flow and proceeds to Step S4.

Returning to FIG. 8, in Step S4, the power system stabilization device 10 uses the generator energy calculated in Step S3 and the threshold and control data D3 to perform threshold determination for determining whether the generator energy exceeds a threshold. Generator energy Elimit′ is calculated by Expression (6). When the generator energy Elimit′ is smaller than a threshold Elimit as expressed by Expression (7), the generator energy is determined to be stable.

[Math. 6]

E′_{A}+E′_{D}=E′ₗᵢₘᵢₜ (6)

where Elimit′ represents the generator energy.

[Math. 7]

Eₗᵢₘᵢₜ>E′ₗᵢₘᵢₜ (where E′_{A}+E′_{D}<0) (7)

where Elimit represents the threshold.

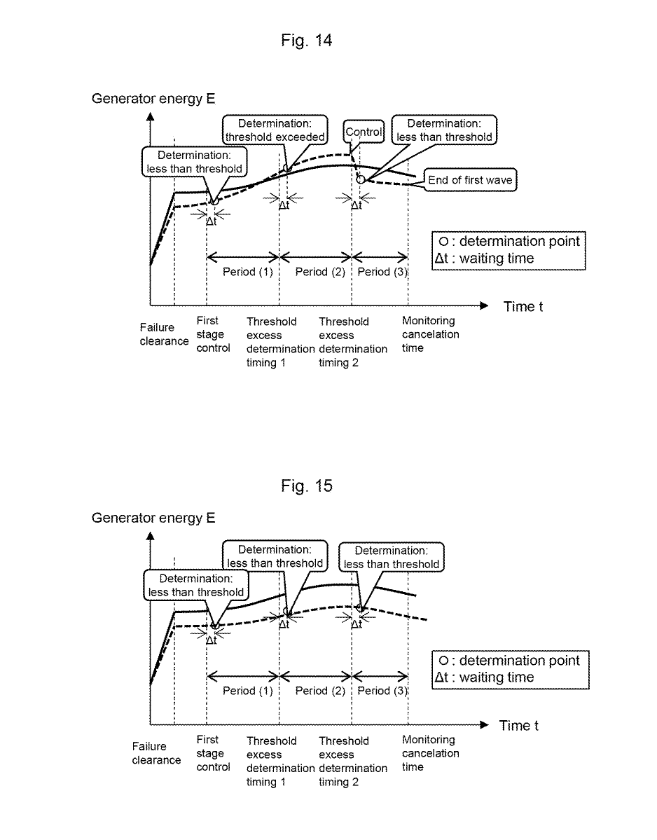

Referring to FIG. 14 and FIG. 15, the flow of the threshold determination is now described. FIG. 14 and FIG. 15 are diagrams for describing an example of processing in the threshold value determining unit 32. FIG. 14 is an example where the generator energy exceeds the threshold. FIG. 15 is an example where the generator energy does not exceed the threshold. In FIGS. 14 and 15, the solid lines represent the threshold, and the broken lines represent the calculated generator energy E.

FIG. 14 is an example where three periods are set for a threshold that changes with time. The first period (period (1)) starts from a time point at which, after the clearance of a failure, first-stage control is executed immediately when the failure has occurred by using the conventional control function included in the central stabilizer 210 and the power system stabilization device 10 to a threshold excess determination timing 1 set in advance. In the period (1), threshold excess determination is executed once at a timing at which Δt has elapsed from the execution of the first-stage control in order to confirm the effect of the first-stage control. Δt is set in advance to a value that takes a time period necessary for the calculation of measured data into consideration.

The second period (period (2)) is a period from the threshold excess determination timing 1 to the next threshold excess determination timing 2. The period width of the period (2) is set in advance. Also in the period (2), threshold excess determination is executed once at a timing at which Δt has elapsed from the threshold excess determination timing 1. Δt in the period (2) is not necessarily required to be the same as Δt in the period (1).

The third period (period (3)) is a period from the threshold excess determination timing 2 to a monitoring cancellation time. The period width of the period (3) is also set in advance. Also in the period (3), threshold excess determination is executed once at a timing at which Δt has elapsed from the threshold excess determination timing 2. Δt in the period (1) and the period (2) and Δt in the period (3) are not necessarily required to be the same.

FIG. 14 illustrates how the excess determination is executed on the above-mentioned threshold and periods when the generator energy changes as indicated by the dotted line.

In the threshold determination in the period (1), it is determined that the generator energy is less than the threshold and is stable. In the threshold determination in the period (2), however, it is determined that the generator energy exceeds the threshold and is unstable, and control is executed. This control decreases the generator energy, and in the threshold determination in the period (3), it is determined that the generator energy is less than the threshold and is stable. The control is executed immediately when the generator energy is determined to be unstable in the threshold determination in the period (2), and hence the threshold determination in the period (3) may be omitted.

Next, FIG. 15 is an example where generator energy is determined to be less than a threshold and be stable in any of the period (1) to the period (3) and the control is unnecessary unlike FIG. 14. The number of periods and the monitoring cancellation time are determined in advance on the basis of one or both of a limit time necessary for the generator energy to be stable by the control and a first wave end time.

Returning to FIG. 8, when it is determined in Step S4 that the generator energy has exceeded a threshold, in Step S5, the power system stabilization device 10 uses the failure data D6 and the threshold and control data D3 to select a control command associated with the condition that the failure has occurred, and stores the determination result indicating that the failure has occurred as well as the content of the selected control command. In this example, the determination result together with the control command is stored, but the control command is not necessarily required to be stored.

In Step S6, the power system stabilization device 10 transmits the control command selected in Step S5 and the determination result stored in Step S5 to the generator control apparatus 160 and the central stabilizer 210, respectively, and finishes the processing. Then, the power system stabilization device 10 returns to Step S1.

When, for example, the communication traffic increases, the determination result is not necessarily required to be transmitted in real time in order to prevent reduce the communication traffic and prevent an overload on the communication network 300.

In Step S4, when the generator energy does not exceed a threshold until the monitoring cancellation time in the threshold determination, the power system stabilization device 10 finishes the calculation and returns to Step S1.

The control (correction control) after the threshold determination described above is conventional control for correcting the first-stage control.

Next, calculation processing contents of the central stabilizer 210 are described.

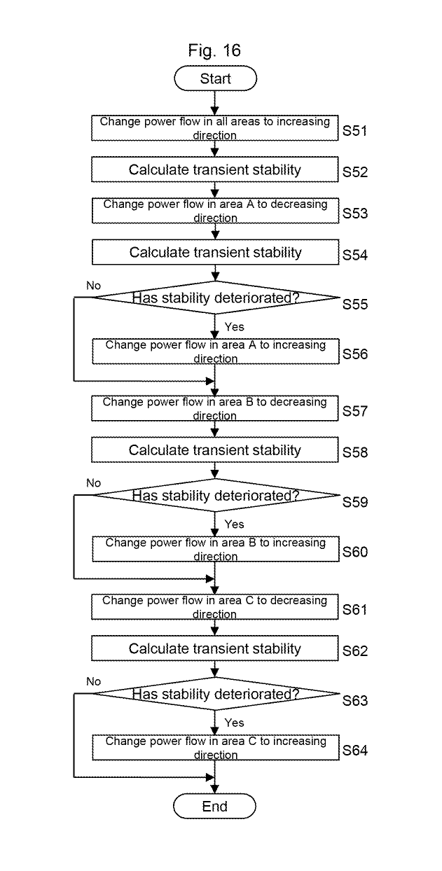

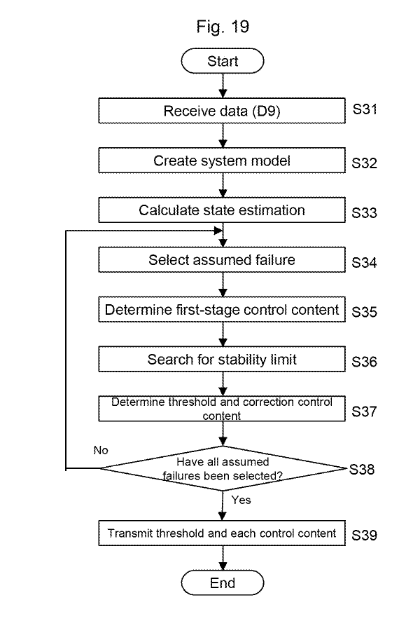

FIGS. 16 to 18 are diagrams for describing a configuration example of the central stabilizer 210. FIG. 19 is a flowchart for describing an overall process of the central stabilizer 210. The overall process is briefly described. First, system data D9, assumed failure data D6′, search range data D10, and determination result data D7 that are manually input or automatically received are used to perform state estimation and power flow calculation, thereby calculating and storing an appropriate system state. Examples of the system data D9 include system topology, active power, reactive power, voltage, impedance, earth capacitance, and a transformer tapping ratio for a substation. The assumed failure data D6′ is a list of failures to be controlled among possible failures. The search range data D10 is the range of a power flow that can flow through a control subject location in a substation, and the range of the amplitude of a load value for stability limit search is determined by the search range data D10. Subsequently, stability calculation is performed on the assumed failure data D6′ to determine a first-stage control detail for each failure that can occur in the power system indicated by the assumed failure data D6′. After that, the stability limit is searched for, and generator energy at the stability limit is calculated. The calculated generator energy is used as a threshold, and a correction processing content corresponding to the threshold is calculated. The obtained results are transmitted to the power system stabilization device 10 as the first-stage control data D11 and the threshold and control data D3. The control effect and the determination control result data D7, which are obtained when a failure has actually occurred and the first-stage control is executed and the threshold determination is performed, are displayed on a screen. The flow of the above-mentioned processing is described in detail below. Descriptions of contents overlapping with those of the power system stabilization device 10 described above with reference to FIG. 1 to FIG. 15 are omitted.

FIG. 16 is an example of an overall configuration diagram of the central stabilizer 210 according to this embodiment. The central stabilizer 210 includes a control detail determining unit 34 and various kinds of databases. The control detail determining unit 34 includes a state estimation/power flow calculation unit 35, a stability calculation unit 36, a first-stage control detail calculation unit 37, a stability limit search unit 38, a generator phase difference calculation unit 30b, a generator energy calculation unit 31b, and a threshold and correction control detail calculation unit 39. The databases included in the central stabilizer 210 are a system database 29 storing the system data D9, an assumed failure database 26b storing the assumed failure data D6′, a search range database 40 storing the search range data D10, a determination result database 27b storing the determination result data D7, a first-stage control database 41 storing the first-stage control data D11, a stability limit database 42 storing stability limit data D12, and a threshold and control database 23b storing the threshold and control data D3.

Data treated by the central stabilizer 210 are the system data D9, the assumed failure data D6′, the search range data D10, the determination result data D7, the first-stage control data D11, the stability limit data D12, the threshold and control data D3, and the determination control result data D7.

The state estimation/power flow calculation unit 35 in the control detail determining unit 34 calculates and stores an appropriate system state by using the system data D9. The appropriate system state can be obtained, for example, by determining an assumed predetermined function coefficient from measured data by the method of least squares. The first-stage control detail calculation unit 37 in the control detail determining unit 34 determines a control detail of the first-stage control by using the system data D9, the state estimation result, the assumed failure data D6′, and the stability calculation unit 36. The stability limit search unit 38 in the control detail determining unit 34 searches for a stability limit by using the system data D9, the state estimation result as the appropriate system state, the search range data D10, the assumed failure data D6′, and the stability calculation unit 36. The generator phase difference calculation unit 30b in the control detail determining unit 34 calculates a generator phase difference on the basis of the stability calculation result. The generator energy calculation unit 31b in the control detail determining unit 34 calculates generator energy on the basis of the generator phase difference and the stability calculation result. The threshold and correction control detail calculation unit 39 in the control detail determining unit 34 calculates the generator energy as a threshold for each period, and determines a correction processing content by using the stability limit search result, the system data D9, the assumed failure data D6′, and the stability calculation unit 36. The control detail determining unit 34 transmits the first-stage control data D11 and the threshold and control data D3 to the power system stabilization device 10, and receives the determination result data D7 from the power system stabilization device 10. The power system stabilization device 10 that has received the first-stage control data D11 and the threshold and control data D3 executes threshold determination.

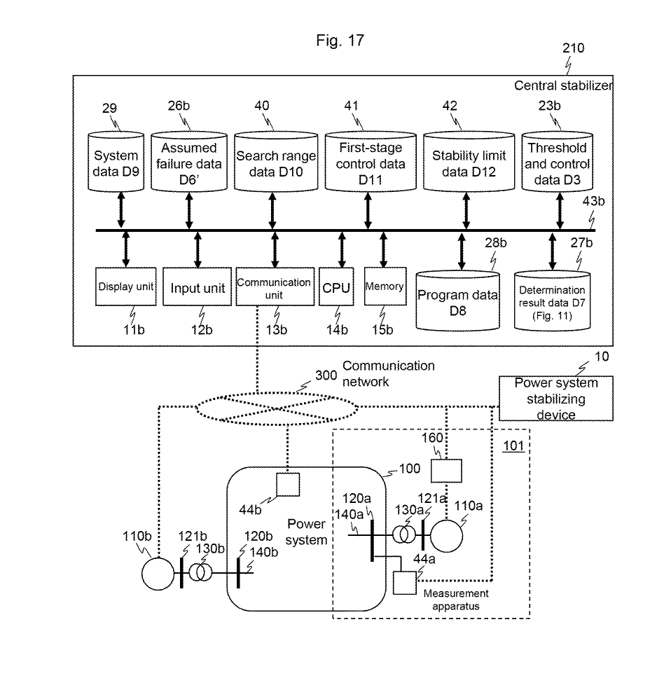

FIG. 17 is a block diagram illustrating an example of a hardware configuration of the central stabilizer 210 and an overall configuration of the power system. In FIG. 17, the central power stabilizer 210, the power system stabilization device 10, the power system 100, the partial power system 101 included in the power system 100, and a generator 110b are coupled to the communication network 300.

The power system 100 is coupled to the generators 110a and 110b, transformers 130a and 130b, and measurement apparatuses 44a and 44b via the branches 140a and 140b, nodes 120a and 120b, and nodes 121a and 121b, respectively. Although not illustrated in FIG. 17, anyone or more of the failure detection apparatus 150, a load, and other measurement apparatus and control apparatus are present. The generators 110a and 110b may each be, in addition to the generator as in this example, an electric power plant including a plurality of generators or a power generating facility of a power generation operator having a plurality of electric power plants.

The central stabilizer 210 has a hardware configuration in which a display unit 11b, an input unit 12b, a communication unit 13b, a CPU 14b, and a memory 15b that are similar to those in the power system stabilization device 10 and various kinds of databases (system database 29, assumed failure database 26b, search range database 40, determination result database 27b, first-stage control database 41, stability limit database 42, threshold and control database 23b, and program database 28b) that are different from those in the power system stabilization device 10 are coupled to a bus line 43b.

The configurations of the generator 110b, the display unit 11b, the input unit 12b, the communication unit 13b, the CPU 14b, and the memory 15b are similar to those of the generator 110a, the display unit 11a, the input unit 12a, the communication unit 13a, the CPU 14a, the memory 15a, and the like respectively.

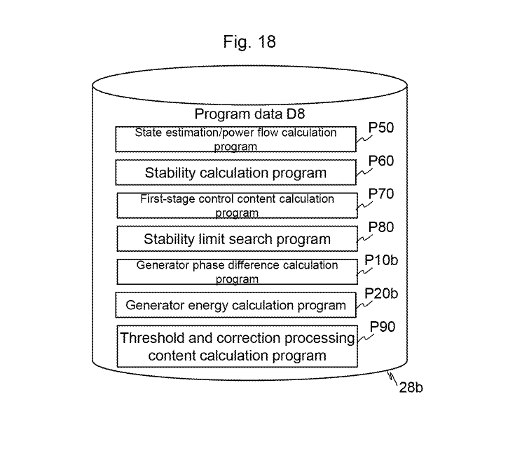

Referring to FIG. 18, stored contents in the program database 28b are described. FIG. 18 is a diagram illustrating a configuration example of program data in the power system stabilization device 210. In the program database 28b, for example, a state estimation/power flow calculation program P50, a stability calculation program P60, a first-stage control detail calculation program P70, a stability limit search program P80, a generator phase difference calculation program P10b, a generator energy calculation program P20b, and a threshold and correction processing content calculation program P90 are stored. The first-stage control detail calculation program P70 and the threshold and correction processing content calculation program P90 have the functions of transmitting controls contents and thresholds to the power system stabilization device 10, respectively. The program group illustrated in FIG. 18 is an example of a program group constituting a configuration example that is not minimum but basic. In another example, a program for adjusting the threshold and/or control detail on the basis of the determination result may be further provided.

Returning to FIG. 17, the CPU 14b executes calculation programs (state estimation/power flow calculation program P50, stability calculation program P60, first-stage control detail calculation program P70, stability limit search program P80, generator phase difference calculation program P10b, generator energy calculation program P20b, and threshold and correction processing content calculation program P90) read from the program database 28b into the memory 15b, thereby executing each processing of, for example, calculating a state estimation/power flow, calculating stability, calculating a first-stage control detail, searching for a stability limit, calculating a generator phase difference, calculating generator energy, calculating a threshold and a correction processing content, instructing image data to be displayed, and searching for data in various kinds of databases. The memory 15b is a memory configured to temporarily store calculation temporary data and calculation result data, such as display image data, control data, and control result data. The image data generated by the CPU 14b are displayed on the display unit 11b (for example, display screen).

Roughly divided eight databases are stored in the central stabilizer 210. The system database 29, the assumed failure database 26b, the search range database 40, the first-stage control database 41, and the stability limit database 42 other than the program database 28b, the determination result database 27b, and the threshold and control database 23b are described below.

The system data D9 in the system database 29 includes system configuration, line impedance, system measurement data (P, Q, V, I, Φ, time stamp-added data, and PMU data), data necessary for system configuration and state estimation (such as threshold for bad data), generator data, and other data necessary for power flow calculation and state estimation/stability calculation. For example, the generator data includes the concept of time, and generator outputs and generator phases may be accumulated in time series. The measurement value may be acquired from a central load dispatching center or an EMS (Energy Management System: power system supply and demand management server), or may be directly acquired from a measurement apparatus disposed at each location in the entire system. When data is manually input, data is manually input from the input unit 12b and stored. For manual input, predetermined image data may be generated by the CPU 14b and displayed on the display unit 11b. For manual input, a complementary function for assisting an operation by an operator may be used such that a large volume of data can be easily set by semi-automatic input.

The assumed failure data D6′ in the assumed failure database 26b includes, as illustrated in FIG. 30, a list of failure locations, failure conditions, and failure clearance timings as assumed failure cases in the power system. For example, the assumed failures in the assumed failure data D6′ may be arranged in the order of severity. Depending on the system operation, only severe failure cases may be included in the assumed failure data D6′. For example, screening based on severity may be performed to classify the assumed failure data D6′ into a plurality of lists.

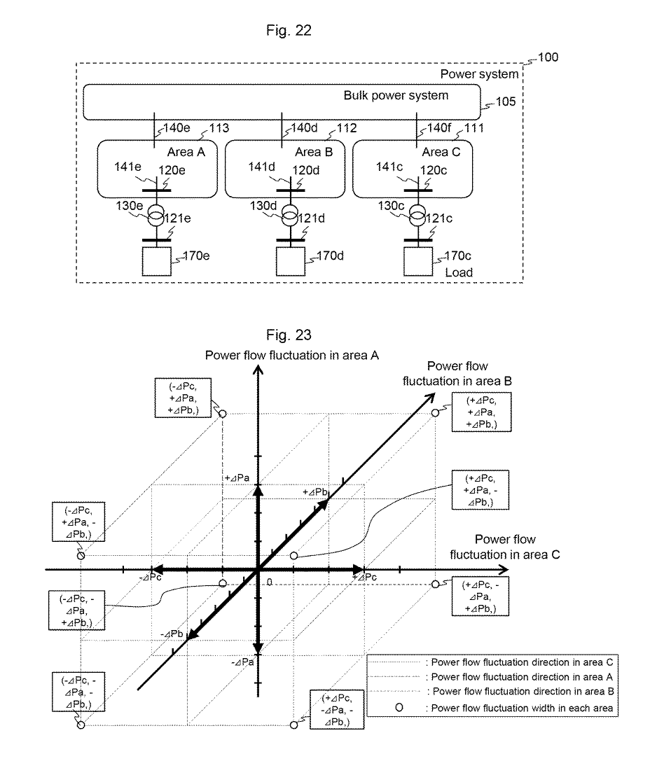

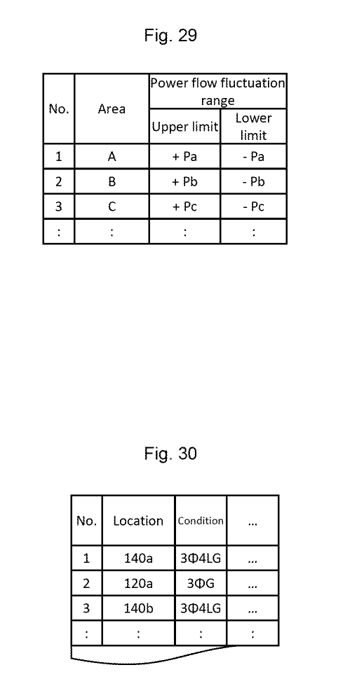

The search range data D10 in the search range database 40 includes, as illustrated in FIG. 29, upper and lower limit values of a power flow fluctuation range for each area for the system data illustrated in FIG. 22. For example, the power flow fluctuation range illustrated in FIG. 29 may be set on the basis of the result of measuring a power flow fluctuation of the power supply and/or load that changes in a predetermined cycle.

The first-stage control data D11 in the first-stage control database 41 includes data that does not include a threshold in the threshold and control data D3 illustrated in FIG. 6.

The stability limit data D12 in the stability limit database 42 includes the relation between a power flow fluctuation amount and a generator internal phase difference angle first wave peak value in every area in the search process, and stability limit positions.

As described above, in this embodiment, the first-stage control by pre-calculation and the corrective stabilization control by post-calculation based on acceleration of generators are combined for a power flow fluctuation that is not assumed by pre-calculation. Consequently, the stability of the power system can be automatically maintained with less labor.

In this embodiment, a time deviation of the voltage phase at the bus of a generator or an electric power plant is used, and hence accurate stabilization control of the generator or the electric power plant can be executed.

As described in the modified example of this embodiment, when a difference between the voltage phase of the bus at a generator or an electric power plant and the voltage phase at a bus at a predetermined distance therefrom is used as the voltage phase angle time deviation, information corresponding to the time deviation can be obtained from the difference in voltage phase at these buses by relatively simple calculation.

In this embodiment, the deviation between average values of phase angles of outputs of generators in a predetermined period of time, which are calculated for each predetermined period of time in the time period excluding immediately before and after the occurrence of a failure, is used as generator phase difference data. Consequently, a fluctuation in measured values due to measurement errors or the like can be removed by averaging to improve the accuracy of stabilization control.

In this embodiment, the energy value calculated by using the generator output and the generator phase difference data is used as an index representing acceleration of the generator, and hence the acceleration of the generator can be accurately grasped from the acceleration energy and deceleration energy. An accurate acceleration index can be obtained by integral calculation based on the generator output and the generator phase difference data.

Next, calculation processing contents in the central stabilizer 210 are described with reference to FIG. 19. FIG. 19 is a flowchart illustrating an example of the whole processing in the central stabilizer 210. The flow of the processing is described below.

First, in Step S31, the central stabilizer 210 receives system data D9 from the measurement apparatuses 44a and 44b. The central stabilizer 210 further receives system data D9 that is set by manual input using the input unit 12b. For example, the central stabilizer 210 receives the system data D9 periodically at a predetermined cycle.

In Step S32, the central stabilizer 210 uses the system data D9 to create a system model from system connection information, power flow information, and the like. In Step S33, the central stabilizer 210 executes state estimation by the state estimation/power flow calculation unit 35, and calculates and stores an appropriate system state. In Step S34, the central stabilizer 210 selects an assumed failure from the assumed failure data D6′. In this case, in order to reduce the calculation volume, the central stabilizer 210 may execute screening for narrowing down assumed accidents to be controlled in accordance with predetermined conditions, rather than sequentially selecting all assumed accidents. In Step S35, the central stabilizer 210 uses the system data D9, the state estimation result, and the stability calculation unit 36 to calculate a control detail of first-stage control by the first-stage control detail calculation unit 37. The content of the first-stage control involves, for example, repeating processing of calculating transient stability for an assumed failure, and when step-out has occurred, selecting a generator to be shed that has reached a threshold most early, and calculating transient stability in the power-controlled state, until a desired system state is achieved, for example, until the power system is stabilized without any step-out. In this case, the generator phase may be calculated by either of the measurement apparatus 44a or the power system stabilization device 10. Examples of desired system states include a system state in which system voltage reactive power is stable, a system state in which consignable power is maximum, and a system state in which distribution loss is minimum. Theses system states can be calculated on the basis of system constraints.

Next, in Step S36, the central stabilizer 210 searches for a stability limit in the search range data D10 in a power flow section of the state estimation result by using the assumed failure data D6′ and the system data D9 and using the stability limit search unit 38 and the stability calculation unit 36.

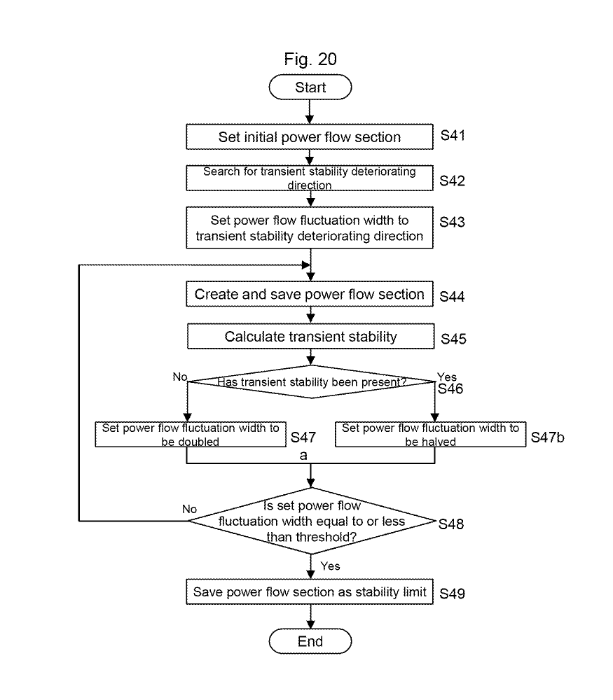

Reference is now made to FIG. 20. FIG. 20 is a flowchart illustrating an example of the stability limit search processing.

In Step S41, the central stabilizer 210 sets data on a power flow obtained by power flow calculation using the state estimation result as an initial power flow section. The initial power flow section is a power flow section at an operating point before a failure.

In Step S42, the central stabilizer 210 searches for a transient stability deteriorating direction.

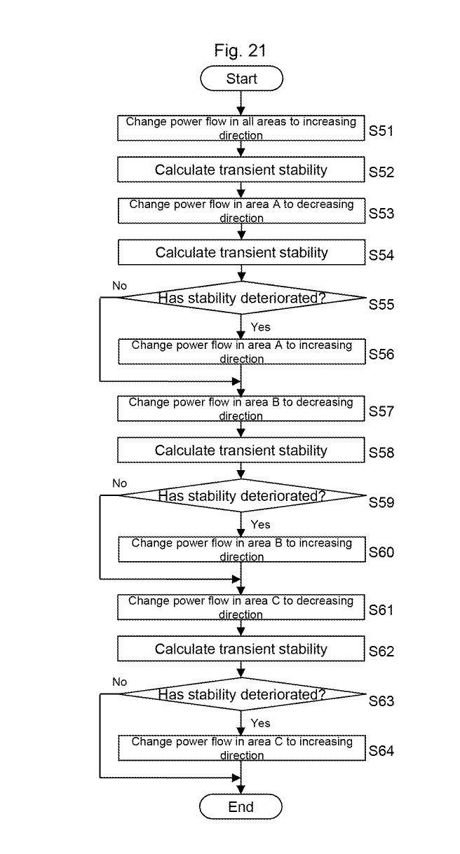

Reference is now made to FIG. 21. FIG. 21 is a flowchart illustrating an example of the processing for searching for the transient stability deteriorating direction. FIG. 21 illustrates an example of processing from Step S51 to Step S64 respectively corresponding to areas A to C obtained by dividing the power system 100 as illustrated in FIG. 22. The number of the divided areas is determined in advance. The stability limit is searched for by varying the load amounts of loads 170c to 170e in the respective areas.

First, in Step S51, the central stabilizer 210 changes the directions of power flows in all the areas to increasing directions. The change width in this case and the change width use thereafter are predetermined increment widths set in advance. In Step S52, the central stabilizer 210 calculates transient stability. Only short analysis is necessary for the stability calculation because only a generator internal phase difference angle first wave peak value needs to be grasped.

In Step S53, the central stabilizer 210 changes the direction of the power flow in the area A to a decreasing direction, and in Step S54, the central stabilizer 210 calculates transient stability again. Next, in Step S55, the central stabilizer 210 compares the stabilities obtained by the transient stability calculation before and after the change of the direction of the power flow, thereby confirming whether the stability has deteriorated.

When the stability has deteriorated, in next Step S56, the central stabilizer 210 corrects the direction of the power flow in the area A to an increasing direction. When the stability has improved, on the other hand, the central stabilizer 210 maintains the direction of the power flow in the area A to the decreasing direction.

Next, in Step S57, the central stabilizer 210 changes the direction of the power flow in the area B to a decreasing direction, and in Step S58, the central stabilizer 210 calculates transient stability again. Next, in Step S59, the central stabilizer 210 compares the stabilities before and after the change of the direction of the power flow, thereby confirming whether the stability has deteriorated.

When the stability has deteriorated, in next Step S60, the central stabilizer 210 corrects the direction of the power flow in the area B to an increasing direction. When the stability has improved, on the other hand, the central stabilizer 210 maintains the direction of the power flow in the area B to the decreasing direction.

Next, in Step S61, the central stabilizer 210 changes the direction of the power flow in the area C to a decreasing direction, and in Step S62, the central stabilizer 210 calculates transient stability again. Next, in Step S63, the central stabilizer 210 compares the stabilities before and after the change of the direction of the power flow, thereby confirming whether the stability has deteriorated.

When the stability has deteriorated, in Step S64, the central stabilizer 210 corrects the direction of the power flow in the area C to an increasing direction. When the stability has improved, on the other hand the central stabilizer 210 maintains the direction of the power flow in the area C to the decreasing direction.

As described above, through the processing for searching for the direction in which the transient stability deteriorates, the change direction of the power flow in each area can be automatically set to the direction in which the stability deteriorates, thereby reducing the subsequent adjustment labor. FIG. 23 is an example illustrating a power flow fluctuation in each area in the processing of searching for the direction in which the transient stability deteriorates. The directions of the power flows in all areas are changed to increasing directions (upper right in FIG. 23), and after that, the power flow in each area is reduced to confirm the direction in which the stability deteriorates (transient stability deteriorating direction).

Returning to FIG. 20, in Step S43, the central stabilizer 210 sets a power flow fluctuation width (value initially used for stability limit search) for the transient stability deteriorating direction determined in Step S42. For setting the power flow fluctuation width, a power flow fluctuation value in a selected area that reaches a step-out determination threshold is calculated and set on the basis of a relation expression among an initial power flow section (operating point before accident) determined for the search of the stability deteriorating direction, a power flow fluctuation in the selected area at a section where the stability is deteriorated, and a generator internal phase difference angle peak value (first wave). An approximation formula is used as the relational expression. The approximation may be linear approximation or quadratic approximation.

In Step S44, the central stabilizer 210 creates and saves a power flow section for the case where the power flow fluctuation set in Step S43 occurs.

In Step S45, the central stabilizer 210 executes transient stability calculation at the power flow section created in Step S44. Then, the central stabilizer 210 compares the previous and current transient stabilities. When the transient stability has changed from a transient unstable state to a transient stable state or changed from the transient stable state to the transient unstable state, the central stabilizer 210 inverts the search direction.

Next, in Step S46, the central stabilizer 210 determines whether a transient unstable power flow section has appeared in the past processing process. When there is a transient unstable power flow section, the central stabilizer 210 resets the power flow fluctuation width set in Step S44 to be halved, and proceeds to the next step. When there is no transient unstable power flow section, on the other hand, the central stabilizer 210 resets the power flow fluctuation width set in Step S44 to be doubled, and proceeds to the next step.

In Step S48, the central stabilizer 210 compares the power flow fluctuation width set in this case with a threshold. When the power flow fluctuation width is equal to or more than the threshold, the central stabilizer 210 returns to Step S44. When the power flow fluctuation width is equal to or less than the threshold, in Step S49, the central stabilizer 210 saves the power flow section calculated last as a stability limit. At the time of saving the power flow section as a stability limit, an unstable power flow section under the last or second last search conditions is also saved.

The stability limit is searched for as described above. The stability limit is searched in accordance with the above-mentioned flow under constraints of the search range data D10.

In this example, a stability limit is searched for while the power flow fluctuation width is set by binary search. In another example, the power flow fluctuation width may be set by random numbers in a maximum fluctuation range, and a stability limit may be searched for by the Monte Carlo method. The search for a stability limit may employ, for example, a search method using a PSO (Practice Swarm Optimization) and optimum power flow calculation in combination. A stability limit may be searched for by another search method.

Returning to FIG. 19, in Step S37, the central stabilizer 210 determines a threshold and a correction processing content.

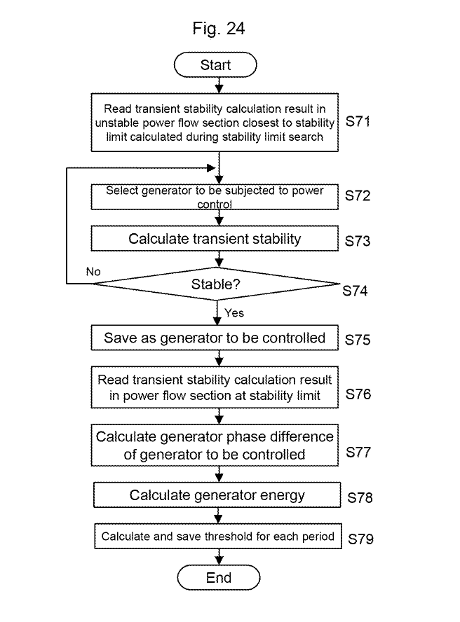

Reference is now made to FIG. 24. FIG. 24 is a flowchart showing an example of the flow of processing from the determination of a shedding generator (control subject generator) to the calculation of generator energy and the calculation of a threshold for each period.

In Step S71, the central stabilizer 210 reads the calculation result of transient stability in an unstable power flow section closest to the stability limit calculated during the stability limit search, which is saved in Step S49, into the memory 15b. The unstable power flow section is a power flow section that is saved as an unstable power flow section in the last or second last search conditions at the time of saving the power flow section as a stability limit.

In Step S72, the central stabilizer 210 performs stability analysis using the unstable power flow section read in Step S71, and determines generator to be controlled on the basis of the result of the stability analysis. In this case, similarly to the method of selecting a generator subjected to first-stage control, a generator that has reached a step-out determination threshold most early in the unstable power flow section is selected as a generator to be controlled. For example, the number of generators to be shed is increased, or a shedding generator with a larger capacity is selected again.

In another example, in Step S71, the power flow section at the stability limit may be used as an unstable power flow section. In this case, in Step S72, a generator having the largest generator internal phase difference angle first wave peak value is selected.

In Step S73, the central stabilizer 210 calculates transient stability by the stability calculation unit 36 using the system data D9 and the assumed failure data D6′ in the same unstable power flow section, and in Step S74, the central stabilizer 210 determines whether the transient stability as the calculation result is stable. When the transient stability is unstable, the central stabilizer 210 increases the number of generators to be shed until the transient stability is stable. In this case, an upper limit of the number of generators to be shed is set in advance. When the transient stability is stable, on the other hand, the central stabilizer 210 finally determines the selected control subject generator, and in Step S75, saves data on the control subject generator.

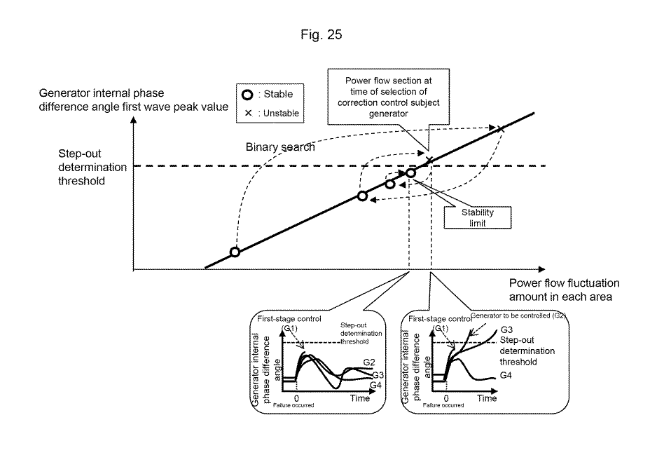

Reference is now made to FIG. 25. FIG. 25 is a diagram for describing processing in the stability limit search unit 38. FIG. 25 illustrates an example of the manner of stability limit search in a relational diagram of the power flow fluctuation amount in each area and the generator internal phase difference angle first wave peak value, and an image of an unstable power flow section used for the search and the selection of stability limit and control subject generator, and an image of a method of determining a control subject generator and the determination of correction processing contents.

How the stability limit search is executed by binary search is indicated by the broken-line arrow. As an image of a power flow section in a region where the generator internal phase difference angle first wave peak value is equal to or more than a step-out determination threshold, a transient state in which the generator internal phase difference angle exceeds the step-out determination threshold is illustrated. As an image of a power flow section in a region where the generator internal phase difference angle first wave peak value is equal to or less than the step-out determination threshold, a transient state in which the generator internal phase difference angle does not exceed the step-out determination threshold but converges is illustrated.

Next, in Step S76, the central stabilizer 210 reads the power flow section at the stability limit and the calculation result of the transient stability into the memory 15b. In Step S77, the central stabilizer 210 calculates a generator phase difference of the control subject generator saved in Step S75 by the generator phase difference calculation unit 30b in the calculation result of the transient stability of the power flow section at the stability limit. The calculation of the generator phase difference and the calculation of the generator energy in this case are performed by processing similar to that in the power system stabilization device 10. The generator phase differences are calculated until the first wave peak value, and are integrated for each period to calculate generator energy and determine a threshold. In Step S78, the central stabilizer 210 calculates generator energy by the generator energy calculation unit 31b.

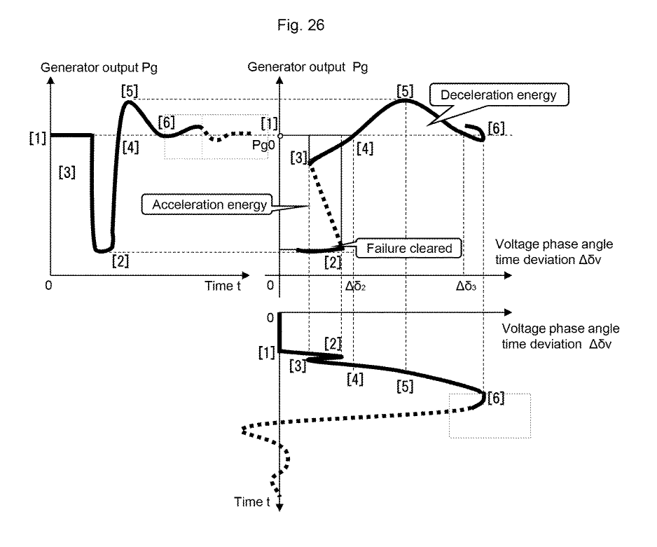

Reference is now made to FIG. 26. FIG. 26 is a diagram illustrating a waveform of generator output Pg-voltage phase angle time deviation Δδv, which is illustrated by two time-series waveforms of generator output Pg-time t and voltage phase angle time deviation Δδv-time t.

In FIG. 26, a hatched region where the generator output Pg is smaller than the initial generator output Pg0 represents acceleration energy, and another hatched region where the generator output Pg is larger than the initial generator output Pg0 represents deceleration energy. Locations denoted by the same numerals [1] to [6] in FIG. 26 indicate corresponding locations in the respective graphs. As illustrated at the upper right in FIG. 26, generator energy can be calculated by integrating the generator output Pg with the voltage phase angle time deviation Δδv.

The acceleration energy and the deceleration energy based on the generator output Pg and the voltage phase angle time deviation Δδv can be determined by Expression (8) and Expression (9), respectively. The generator output Pg may be the sum of outputs of a plurality of generators included in an electric power plant. The voltage phase angle time deviation may be an electric power plant bus voltage phase angle time deviation.

$$\begin{matrix}[ Math . 8 ] & \\ {E}_{A} = {\int }_{0}^{{Δδ}_{2}} ( {P}_{g 0} - {P}_{g} ) d Δδ & ( 8 ) \\ [ Math . 9 ] & \\ {E}_{D} = {\int }_{{Δδ}_{2}}^{{Δδ}_{3}} ( {P}_{g 0} - {P}_{g} ) d Δδ & ( 9 )\end{matrix}$$

where EA represents the acceleration energy and ED represents the deceleration energy.

Returning to FIG. 24, in Step S79, the central stabilizer 210 calculates generator energy for each period by the threshold and correction control detail calculation unit 39, and sets the calculated generator energy as a threshold. In this case, the threshold is determined by the sum of acceleration energy and deceleration energy, and can be determined by Expression (10).

[Math. 10]

E_{A}+E_{D}=Eₗᵢₘᵢₜ (10)

where Elimit represents the threshold.

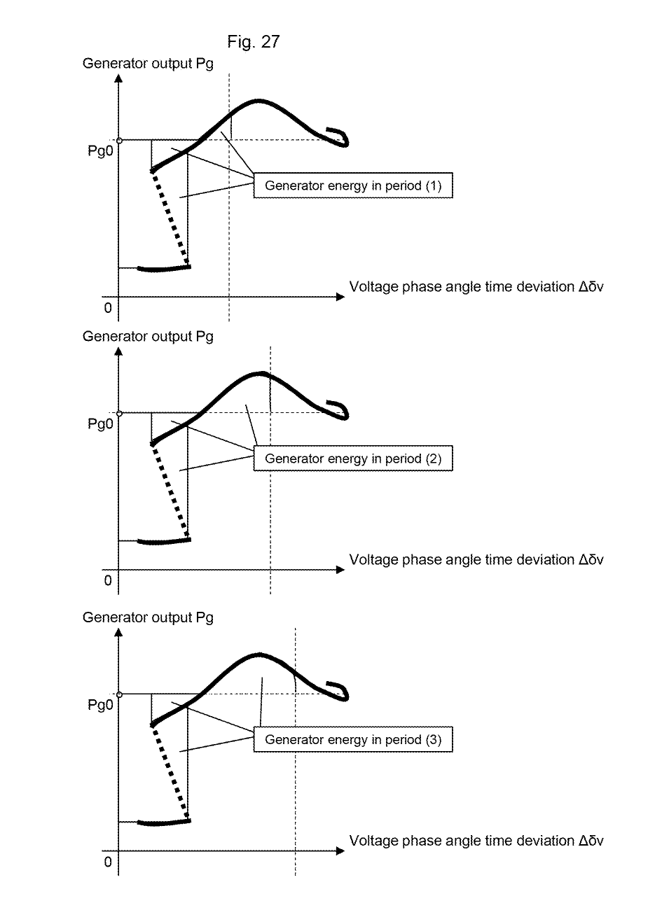

Reference is now made to FIG. 27. FIG. 27 is a diagram for describing the processing in the threshold and correction control detail calculation unit 39. FIG. 27 illustrates time divided images of generator energy for calculating thresholds for the periods (1) to (3). FIG. 27 illustrates how to calculate the thresholds for the periods (1) to (3) in ascending order. The threshold for each period is determined on the basis of generator energy that is determined by integral calculation from failure clearance to each period. Calculating generator energy in a time division manner can provide thresholds for the respective periods. This configuration enables a threshold to be set for a severe failure. Depending on a failure, there is not so much temporal margin from first-stage control to correction control, and hence it is necessary to the period to be short.

Returning to FIG. 24, in Step 79, the central stabilizer 210 calculates and saves the generator energy as a threshold for each period in the manner described above.

Returning to FIG. 19, in Step S38, the central stabilizer 210 determines whether Steps S33 to S37 have been finished and the first-stage control data D11 and the threshold and control data D3 have been determined for all assumed failures. When the processing has not been finished for all assumed failures, the central stabilizer 210 returns to Step S34. When the processing has been finished and the first-stage control data D11 and the threshold and control data D3 have been finished for all assumed failures, the central stabilizer 210 proceeds to next Step S39.

In Step S39, the central stabilizer 210 transmits the determined first-stage control data D11 and threshold and control data D3 to the power system stabilization device 10. This transmission cycle is, for example, a constant cycle determined in advance.

The central stabilizer 210 may display operating states, such as the state in which the power system is under monitoring, the threshold has been exceeded, and the control is being executed, on the screen. This configuration enables an operator to easily grasp the operation states of the power system stabilization device 10. In this case, until the control is executed, the states from the reception of various kinds of data to the transmission of the control command and determination result may be repeatedly displayed on the screen. Further, the displaying of generator output, generator energy, and threshold determination result enables an operator to examine later whether the control determination was correct.

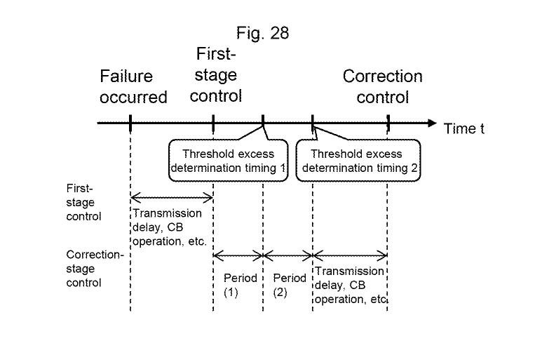

Reference is now made to FIG. 28. FIG. 28 is an example of a time chart illustrating timings of failure occurrence and each control of the power system stabilization device 10. FIG. 28 is an example where correction control based on determination of threshold excess determination timing 2 is executed in addition to the first-stage control. The time chart as in FIG. 28 may be displayed on the screen of the central stabilizer 210. This configuration is advantageous in that an operator can easily grasp the control timings and operations therefor.

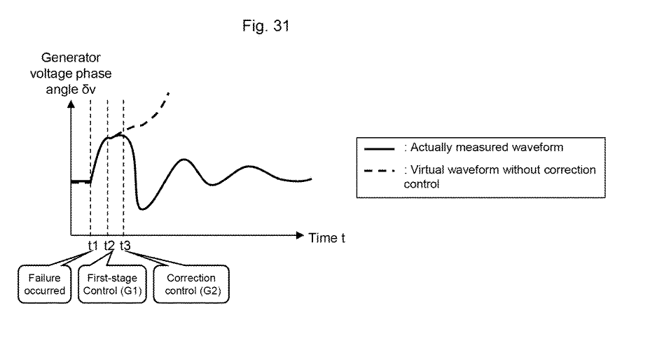

Reference is now made to FIG. 31. FIG. 31 is a graph illustrating a temporal change of the generator voltage phase angle δv. The graph as in FIG. 31 may be displayed on the screen of the central stabilizer 210. An operator can grasp control effects of the power system stabilization device 10 at a glance. The operator can save and display stabilization measures for past assumed accidents, which are used as a reference for creating a system plan.

As described above, in this embodiment, a stability limit at which the power system becomes unstable if the power flow of the power system is further changed when the power flow of the power system is changed from a stable state such that stability is deteriorated for each failure that possibly occurs in the power system is determined, and a value of the acceleration index at the stability limit is determined as the threshold. Consequently, a threshold appropriate for each failure can be determined.

In this embodiment, a plurality of thresholds may be determined for an elapsed time from the occurrence of a failure. With this configuration, it can be determined a plurality of times with the lapse of time whether the acceleration index exceeds a threshold, and appropriate determination results with the lapse of time can be obtained.

The above-mentioned embodiments of this invention are illustrative for describing this invention and are not intended to limit the scope of this invention to the embodiments. A person skilled in the art can carryout this invention in various other forms without departing from the gist of this invention.

### REFERENCE SIGNS LIST

10 Power system stabilization device
11a, 11b Display unit
12a, 12b Input unit
13a, 13b Communication unit
14a, 14b CPU
15a, 15b Memory
20 Generator phase data
21 Generator output database
22 Generator phase difference database
23a, 23b Threshold and control database
24a, 24b Program database
25 Control command database
26a Failure database
26b Assumed failure database
27a, 27b Determination result database
28a, 28b Program database
29 System database
30a, 30b Generator phase difference calculation unit
31a, 31b Generator energy calculation unit
32 Threshold value determining unit
33 Control command unit
34 Control detail determining unit
35 state estimation/power flow calculation unit
36 Transient stability calculation unit
37 First-stage control detail calculation unit
38 Stability limit search unit
39 Threshold and correction control detail calculation unit
40 Search range database
41 First-stage control database
42 Stability limit database
43a, 43b Bus line
44a, 44b Measurement apparatus
51 Generator output data
52 Generator phase data
53 Threshold and control data
56 Failure data
57 Determination control result data
58 Control command data
59 First-stage control data
100 Power system
105 Bulk power system
101, 111-113 Partial power system
110a-110c Generator
120a-120e, 121a-121e Node (bus)
130a-130e Transformer
140a-140f, 141a-141e Branch (line)
150 Failure detection apparatus
160 Generator control apparatus
170c-170e Load
210 Central stabilizer
300 Communication network

1. A power system stabilization device performing stabilization control of a power system,
the power system stabilization device comprising:
an indicator calculation unit configured to calculate, by using a generator output that is an output of a generator configured to supply electric power to the power system and a generator phase difference that indicates a change of a phase angle of the generator output with respect to time, an acceleration index that is an index representing an acceleration of the generator;
a threshold value determining unit configured to determine whether the acceleration index exceeds a threshold set in advance; and
a control command unit configured to issue, when the acceleration index exceeds the threshold, a control command for control details for correcting the stabilization control, which are set for the threshold in advance.

2. The power system stabilization device according to claim 1, wherein the generator phase difference is a time deviation of a voltage phase of a bus for the generator or a bus for an electric power plant including the generator.

3. The power system stabilization device according to claim 1, wherein the generator phase difference is a difference between a voltage phase of a bus for the generator or a bus for an electric power plant including the generator and a voltage phase of a bus at a predetermined distance from the generator.

4. The power system stabilization device according to claim 1, wherein the generator phase difference is a deviation between average values of phase angles of output of the generator in a predetermined period, which are calculated every predetermined period, in a period excluding times immediately before and immediately after occurrence of a failure.

5. The power system stabilization device according to claim 1, further comprising:
a generator phase database configured to hold the generator phase difference information; and
a generator output database configured to hold the generator output.

6. The power system stabilization device according to claim 1, wherein the acceleration index is an energy value calculated with use of the generator output and the generator phase difference.

7. The power system stabilization device according to claim 6, wherein the acceleration index is an energy value determined by integrating the generator output with respect to the generator phase difference.

8. The power system stabilization device according to claim 1, wherein the threshold is determined in a manner that, when a power flow of the power system is changed from a stable state such that stability is deteriorated for each failure that possibly occurs in the power system, a stability limit, at which the power system becomes unstable in a case where the power flow of the power system is further changed, is determined, and a value of the acceleration index at the stability limit is determined as the threshold.

9. The power system stabilization device according to claim 1, wherein the threshold is one or more thresholds that are set for an elapsed time from occurrence of a failure in order to determine once or a plurality of times whether the acceleration index exceeds the threshold.

10. The power system stabilization device according to claim 1, wherein the threshold excess determining unit is configured to determine whether the acceleration index exceeds the threshold immediately after occurrence of a failure, and transmit a result of the determination to a central stabilizer that is configured to manage one or more electric power plants including an electric power plant to be subjected to control by the power system stabilization device.

11. A power system stabilization method for executing stabilization control of a power system, the power system stabilization method comprising:
calculating, by index calculation means, an acceleration index representing an acceleration of a generator by using an output of the generator and a generator phase difference representing a change of a phase angle of the output of the generator with respect to time;
determining, by threshold determination means, whether the acceleration index exceeds a threshold set in advance; and
issuing, by control command means, when the acceleration index exceeds the threshold, a control command of control details for correcting the stabilization control, which are set for the threshold in advance.
